(19) United States
(12) Patent Application Publication
(10) Pub. No.: US 2026/0133455 A1
(43) Pub. Date: May 14, 2026

(54) LIQUID CRYSTAL LIGHT CONTROL DEVICE

(71) Applicant: Japan Display Inc., Tokyo (JP)

(72) Inventors: Shinichiro OKA, Tokyo (JP); Koichi IGETA, Tokyo (JP); Takeo KOITO, Tokyo (JP)

(21) Appl. No.: 19/443,920

(22) Filed: Jan. 8, 2026

Related U.S. Application Data
(63) Continuation of application No. PCT/JP2024/025062, filed on Jul. 11, 2024.

(30) Foreign Application Priority Data
Jul. 21, 2023 (JP) 2023-119126

(51) Int. Cl. G02F 1/1347; G02F 1/1337; G02F 1/1343

(52) U.S. Cl. CPC G02F 1/1347; G02F 1/1337; G02F 1/134309

(57) ABSTRACT

A liquid crystal light control device includes at least one liquid crystal panel. The at least one liquid crystal panel includes a first substrate provided with a first electrode including a strip-like pattern, and a first alignment film covering the first electrode, a second substrate provided with a second electrode including a strip-like pattern, and a second alignment film covering the second electrode, and a liquid crystal layer disposed between the first substrate and the second substrate. The liquid crystal layer has a thickness of 10 μm or more and liquid crystal molecules are aligned in a twisted manner from a first substrate side toward a second substrate side. A pretilt angle of the liquid crystal molecules controlled by the first alignment film and the second alignment film is 2 degrees or more and less than 8 degrees.

### CROSS-REFERENCE TO RELATED APPLICATIONS

This application is a Continuation of International Patent Application No. PCT/JP2024/025062, filed on Jul. 11, 2024, which claims the benefit of priority to Japanese Patent Application No. 2023-119126, filed on Jul. 21, 2023, the entire contents of which are incorporated herein by reference.

### FIELD

An embodiment of the present invention relates to a liquid crystal light control device that controls the light distribution of light emitted from a light source by using an electro-optic effect of liquid crystal.

### BACKGROUND

A liquid crystal light control device has been disclosed in which a plurality of liquid crystal panels is stacked and a light distribution state of liquid crystals in each liquid crystal panel is controlled to thereby control a light distribution state of illumination (for example, International Patent Publication No. WO2022/176684).

### SUMMARY

A liquid crystal light control device in an embodiment according to the present invention includes at least one liquid crystal panel. The at least one liquid crystal panel includes a first substrate provided with a first electrode including a strip-like pattern, and a first alignment film covering the first electrode, a second substrate provided with a second electrode including a strip-like pattern, and a second alignment film covering the second electrode, and a liquid crystal layer disposed between the first substrate and the second substrate. The liquid crystal layer has a thickness of 10 μm or more and liquid crystal molecules are aligned in a twisted manner from a first substrate side toward a second substrate side. A pretilt angle of the liquid crystal molecules controlled by the first alignment film and the second alignment film is 2 degrees or more and less than 8 degrees.

### BRIEF DESCRIPTION OF DRAWINGS

FIG. 1 is an overview of the liquid crystal light control device according to an embodiment of the present invention.

FIG. 2 is a perspective view of a liquid crystal panel constituting a liquid crystal light control element according to an embodiment of the present invention.

FIG. 3A is a diagram illustrating an electrode structure of a liquid crystal panel constituting the liquid crystal light control element according to an embodiment of the present invention.

FIG. 3B is a diagram illustrating an electrode structure of a liquid crystal panel constituting the liquid crystal light control element according to an embodiment of the present invention.

FIG. 4A is a diagram for explaining operation of a liquid crystal panel constituting the liquid crystal light control element according to an embodiment of the present invention.

FIG. 4B is a diagram for explaining the operation of a liquid crystal panel constituting the liquid crystal light control element according to an embodiment of the present invention.

FIG. 5 is a diagram for explaining a relationship between a chiral material included in a liquid crystal panel constituting the liquid crystal light control element according to an embodiment of the present invention and a thickness of a liquid crystal layer.

FIG. 6 is a diagram for explaining a voltage applied to a liquid crystal panel constituting the liquid crystal light control element according to an embodiment of the present invention, and a state of light distribution control resulting therefrom.

FIG. 7 is a diagram for explaining an example of light distribution control by the liquid crystal light control element according to an embodiment of the present invention.

### DESCRIPTION OF EMBODIMENTS

Hereinafter, embodiments of the present invention are described with reference to the drawings. However, the present invention can be implemented in many different aspects and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements similar to those described previously with respect to previous drawings may be given the same reference sign (or a number followed by a, b, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

In the present specification, the term “light distribution” has its ordinary meaning and indicates a spread of light emitted from a light source, that is, a distribution of luminous intensity (light intensity) in respective directions, and controlling light distribution means intentionally controlling the spread of light emitted from the light source.

In the present specification, “optical rotation” refers to a phenomenon in which a linearly polarized light component rotates its polarization axis when passing through a liquid crystal layer.

In the present specification, an “alignment direction” of an alignment film refers to a direction in which liquid crystal molecules are aligned when the liquid crystal molecules are aligned on the alignment film by performing a process that imparts an alignment regulating force to the alignment film (for example, a rubbing process). When the process performed on the alignment film is a rubbing process, the alignment direction of the alignment film is typically a rubbing direction.

In the present specification, a “direction of extension” of a strip-like electrode refers to a direction in which a long side of a pattern having a short side (width) and a long side (length) extends when the strip-like electrode is viewed in a plan view.

### 1. Overview of Liquid Crystal Light Control Device

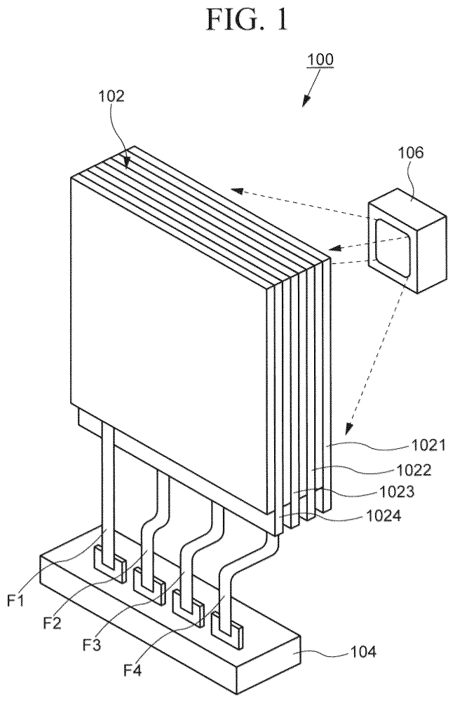

FIG. 1 is a schematic diagram of the configuration of the liquid crystal light control device 100 according to an embodiment of the present invention. The liquid crystal light control device 100 includes a liquid crystal light control element 102 and a control circuit 104. The liquid crystal light control element 102 is formed of a plurality of liquid crystal panels. FIG. 1 illustrates an example in which the liquid crystal light control element 102 is formed of a first liquid crystal panel 1021, a second liquid crystal panel 1022, a third liquid crystal panel 1023, and a fourth liquid crystal panel 1024.

The first liquid crystal panel 1021, the second liquid crystal panel 1022, the third liquid crystal panel 1023, and the fourth liquid crystal panel 1024 are flat panels. The liquid crystal light control element 102 has a structure in which the flat surfaces of the first liquid crystal panel 1021, the second liquid crystal panel 1022, the third liquid crystal panel 1023, and the fourth liquid crystal panel 1024 are arranged so as to overlap each other. The first liquid crystal panel 1021 and the second liquid crystal panel 1022, the second liquid crystal panel 1022 and the third liquid crystal panel 1023, and the third liquid crystal panel 1023 and the fourth liquid crystal panel 1024 are bonded to each other by a transparent adhesive (not illustrated). From a light source 106 side, the first liquid crystal panel 1021, the second liquid crystal panel 1022, the third liquid crystal panel 1023, and the fourth liquid crystal panel 1024 are stacked and arranged in this order.

The liquid crystal light control element 102 is driven by the control circuit 104. In other words, the control circuit 104 outputs control signals for driving the respective liquid crystal panels. As illustrated in FIG. 1, the control circuit 104 is connected to the first liquid crystal panel 1021 via a first flexible wiring board F1, is connected to the second liquid crystal panel 1022 via a second flexible wiring board F2, is connected to the third liquid crystal panel 1023 via a third flexible wiring board F3, and is connected to the fourth liquid crystal panel 1024 via a fourth flexible wiring board F4.

The liquid crystal light control device 100 has a function of controlling the spread of light emitted from the light source 106, that is, a light distribution of light spreading in a predetermined direction. The light source 106 is arranged on a rear side of the liquid crystal light control element 102. Light emitted from the light source 106 is emitted to the outside (an illumination space) through the liquid crystal light control element 102. That is, the light emitted from the light source 106 passes through the first liquid crystal panel 1021, the second liquid crystal panel 1022, the third liquid crystal panel 1023, and the fourth liquid crystal panel 1024 in this order and is emitted to the outside. When light emitted from the light source 106 is irradiated onto the liquid crystal light control element 102, the light passes through the first liquid crystal panel 1021, the second liquid crystal panel 1022, the third liquid crystal panel 1023, and the fourth liquid crystal panel 1024 in this order and is emitted to the outside.

A configuration of the light source 106 is not limited. The light source 106 is formed of, for example, a light-emitting element such as a light-emitting diode, a halogen lamp, a tungsten lamp, a mercury lamp, or a fluorescent lamp, and components such as a reflector. The light source 106 may be a white light source, or may be a light source that emits dimming-adjusted light such as so-called neutral white light or warm white light. An optical element such as a lens may be provided between the light source 106 and the liquid crystal light control element 102.

As described in detail below, the liquid crystal light control device 100 has a function of controlling, by the liquid crystal light control element 102, the light distribution of light emitted from the light source 106. The liquid crystal light control element 102 functions to form a light distribution pattern, such as a square, cross, or line shape, on the irradiated surface of the light-emitting surface from the light source 106 by means of a control voltage output from the control circuit 104.

### 2. Liquid Crystal Panel

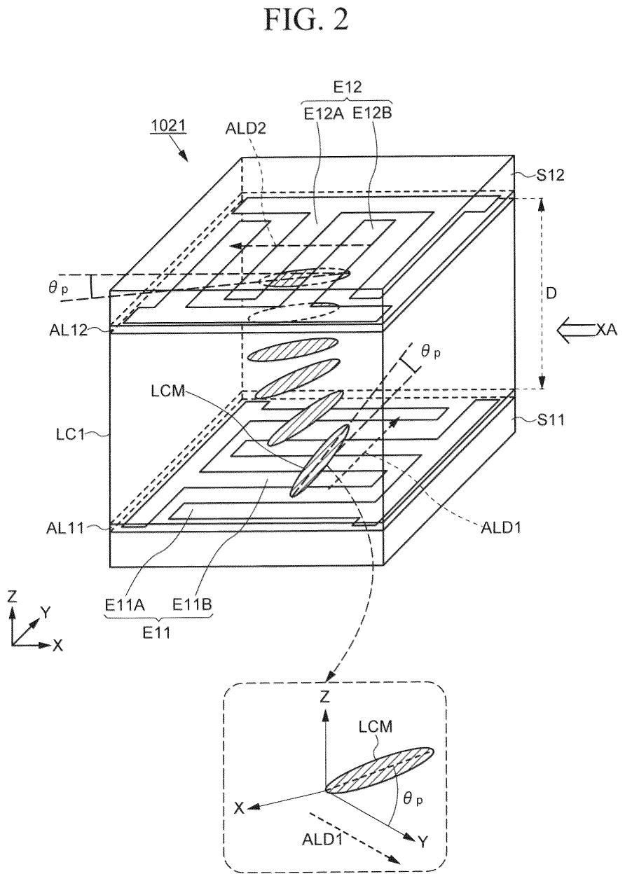

FIG. 2 is a perspective view of a first liquid crystal panel 1021 constituting the liquid crystal light control element 102. FIG. 2 shows X-axis, Y-axis, and Z-axis directions for purposes of explanation. The X-axis direction and the Y-axis direction are orthogonal to each other in a plan view, and the Z-axis direction extends in a normal direction with respect to an X-Y plane. In the following description, expressions such as the X-axis direction, the Y-axis direction, and the Z-axis direction are used to specify directions, but these expressions can be replaced with expressions such as a first direction for the X-axis direction, a second direction for the Y-axis direction, and a third direction or a vertical direction for the Z-axis direction.

The first liquid crystal panel 1021 includes a first substrate S11, a second substrate S12, a first electrode E11, a second electrode E12, a first alignment film AL11, a second alignment film AL12, and a first liquid crystal layer LC1. The first electrode E11 and the first alignment film AL11 are provided on the first substrate S11, and the second electrode E12 and the second alignment film AL12 are provided on the second substrate S12. The first alignment film AL11 is provided to cover the first electrode E11, and the second alignment film AL12 is provided to cover the second electrode E12. The first substrate S11 and the second substrate S12 are arranged spaced apart from and facing each other. The first electrode E11 and the second electrode E12 are disposed on surfaces of the first substrate S11 and the second substrate S12 that face each other. The first liquid crystal layer LC1 is disposed between the first substrate S11 and the second substrate S12.

The first electrode E11 includes a plurality of first strip-like electrodes E11A and a plurality of second strip-like electrodes E11B having strip-like patterns. The second electrode E12 includes a plurality of third strip-like electrodes E12A and a plurality of fourth strip-like electrodes E12B having strip-like patterns. The first strip-like electrodes E11A and the second strip-like electrodes E11B are alternately arranged on an insulating surface of the first substrate S11, and the third strip-like electrodes E12A and the fourth strip-like electrodes E12B are alternately arranged on an insulating surface of the second substrate S12.

The plurality of strip-like patterns of the first strip-like electrodes E11A and the second strip-like electrodes E11B have longitudinal directions that extend in the X-axis direction. The plurality of strip-like patterns of the third strip-like electrodes E12A and the fourth strip-like electrodes E12B have longitudinal directions that extend in the Y-axis direction. Accordingly, a direction of extension in which the plurality of strip-like patterns of the first strip-like electrodes E11A and the second strip-like electrodes E11B extend and a direction of extension in which the plurality of strip-like patterns of the third strip-like electrodes E12A and the fourth strip-like electrodes E12B extend are orthogonal to each other (intersect at 90 degrees). The relative arrangement between the first strip-like electrodes E11A and the second strip-like electrodes E11B and the third strip-like electrodes E12A and the fourth strip-like electrodes E12B is not limited to an orthogonal relationship, and may be varied within a range of ±10 degrees with respect to 90 degrees.

In addition, each strip-like pattern of these strip-like electrodes may be partially bent while extending in a predetermined direction. In this case, the strip-like pattern has a plurality of directions of extension in a longitudinal direction, and each direction of extension may be inclined by about ±10 degrees with respect to the X-axis direction or the Y-axis direction. Similarly, a configuration in which the strip-like pattern of the strip-like electrode is partially curved while extending in a predetermined direction can also be adopted. In this case, a direction of a tangent at each position of the strip-like pattern is regarded as a direction of extension, and each direction of extension may be inclined within a range of about ±10 degrees with respect to the X-axis direction or the Y-axis direction.

In addition, a direction of extension in which the plurality of strip-like patterns constituting the first strip-like electrodes E11A and the second strip-like electrodes E11B extend may be inclined within a range from 30±10 degrees to 60±10 degrees with respect to the X-axis direction. Similarly, a direction of extension in which the plurality of strip-like patterns constituting the third strip-like electrodes E12A and the fourth strip-like electrodes E12B extend may be inclined within a range from 30±10 degrees to 60±10 degrees with respect to the Y-axis direction.

An alignment direction ALD1 of the first alignment film AL11 is directed in a direction (Y-axis direction) that intersects a direction of extension in which the first strip-like electrodes E11A and the second strip-like electrodes E11B extend, and an alignment direction ALD2 of the second alignment film AL12 is directed in a direction (X-axis direction) that intersects a direction of extension in which the third strip-like electrodes E12A and the fourth strip-like electrodes E12B extend. An angle at which the direction of extension in which the first strip-like electrodes E11A and the second strip-like electrodes E11B extend and the alignment direction ALD1 intersect, and an angle at which the direction of extension in which the third strip-like electrodes E12A and the fourth strip-like electrodes E12B extend and the alignment direction ALD2 intersect, can be set within a range of 90±10 degrees.

The first substrate S11 and the second substrate S12 are arranged to face each other with a spacing of 10 μm or greater. For example, the first substrate S11 and the second substrate S12 are arranged with a spacing in a range of 10 μm or greater and 1000 μm or less, preferably 20 μm or greater and 100 μm or less. A first liquid crystal layer LC1 provided between the first substrate S11 and the second substrate S12 has a thickness D. Although the first electrode E11 and the second electrode E12, and the first alignment film AL11 and the second alignment film AL12 are provided between the first substrate S11 and the second substrate S12, film thicknesses of these members are sufficiently small to be negligible as compared with the spacing between the first substrate S11 and the second substrate S12. Therefore, the spacing between the first substrate S11 and the second substrate S12 can be regarded as the thickness D of the first liquid crystal layer LC1. That is, the thickness D of the first liquid crystal layer LC1 can be regarded as having a size in a range of 10 μm or greater and 1000 μm or less, preferably 20 μm or greater and 100 μm or less. Although not illustrated in FIG. 2, spacers may be provided between the first substrate S11 and the second substrate S12.

As a liquid crystal material forming the first liquid crystal layer LC1, for example, a twisted nematic (TN) liquid crystal is used. As schematically shown in FIG. 2, liquid crystal molecules have an elongated rod-like structure due to their molecular structure. Physical properties differ between a long-axis direction (a direction parallel to a molecular long axis) and a short-axis direction (a direction perpendicular to the molecular long axis) of the rod-like liquid crystal molecules. Specifically, it is known that they have dielectric anisotropy as a difference in electrical properties and refractive index anisotropy as a difference in optical properties. The liquid crystal panel constituting the liquid crystal light control element 102 is provided with the first alignment film AL11 and the second alignment film AL12 in order to control an alignment direction of the liquid crystal molecules and an average tilt angle (pretilt angle) with respect to a substrate surface.

As shown in FIG. 2, the liquid crystal molecules LCM have a pretilt angle θp. The pretilt angle θp of the liquid crystal molecules LCM is controlled by the first alignment film AL11 and the second alignment film AL12. As shown in an inset of FIG. 2, the pretilt angle refers to an angle θp at which a long-axis direction of the liquid crystal molecules rises with respect to a substrate surface. The pretilt angle θp is an angle that the liquid crystal molecules have in a state where no electric field is applied (an initial alignment state).

As materials forming the first alignment film AL11 and the second alignment film AL12, organic materials are used. For example, a polyimide-based material is used as the organic material. A rubbing process is performed in order to impart an alignment regulating force to a polyimide-based alignment film. The rubbing process is a process of rubbing a surface of the alignment film while rotating at high speed a roller around which a cloth is wound. In the rubbing process, a direction in which the rubbing roller rubs is a rubbing direction, that is, serves as an alignment direction in which the liquid crystal molecules are aligned. A pretilt angle of the liquid crystal molecules is roughly determined by materials of the alignment film and the liquid crystal material, and fine adjustment of the angle is achievable by processing conditions of the rubbing process.

FIG. 2 shows that an alignment direction ALD1 (rubbing direction) of the first alignment film AL11 is a direction parallel to the Y-axis, and that an alignment direction ALD2 (rubbing direction) of the second alignment film AL12 is a direction parallel to the X-axis. Furthermore, as shown in detail in the insert in FIG. 2, the liquid crystal molecules LCM on the first substrate S11 side have a pre-tilt angle θp, rising in the Z-axis direction, while aligned in the Y-axis direction. Although the inset of FIG. 2 illustrates only a state of the liquid crystal molecules LCM on a side of the first alignment film AL11, the same applies to a side of the second alignment film AL12. That is, on the first substrate side, a long-axis direction of the liquid crystal molecules LCM is oriented so as to intersect a longitudinal direction of a strip-like pattern of the first electrode E11, and on a second substrate side, the long-axis direction of the liquid crystal molecules LCM is oriented so as to intersect a longitudinal direction of a strip-like pattern of the second electrode, and the liquid crystal molecules LCM have the pretilt angle θp.

Control of the alignment directions ALD1 and ALD2 of the first alignment film AL11 and the second alignment film AL12 may be achieved by a photo-alignment process instead of the rubbing process. The photo-alignment process is a process of irradiating a photosensitive polymer alignment film with linearly polarized ultraviolet light from an oblique direction. In the photo-alignment process, photo-reactive molecules are obliquely aligned by polarization of the linearly polarized light, and when the liquid crystal molecules come into contact with the alignment film formed in this manner, an optical alignment state is transferred to the liquid crystal molecules, so that alignment control becomes possible. In the photo-alignment process, not only an irradiation direction of the linearly polarized light but also an irradiation angle can be adjusted, and this enables control of the pretilt angle of the liquid crystal molecules.

An inorganic insulating film may be used as the first alignment film AL11 and the second alignment film AL12. The inorganic insulating film used as an alignment film is, for example, an inorganic insulating film having a groove structure or a columnar structure. Such an inorganic insulating film having a characteristic structure can be produced by a vacuum deposition method, and more specifically, can be produced by oblique deposition. The material forming the inorganic insulating film is not limited, and, for example, a silicon oxide film can be used.

An alignment film formed of an inorganic material and having a groove structure or a columnar structure makes it possible to control an alignment direction and a pretilt angle of liquid crystal molecules by such a characteristic structure. That is, in oblique deposition, a shape of the groove structure or the columnar structure can be changed by an angle between an incident direction of deposition particles and a normal direction of a substrate, and this enables control of the alignment direction and the pretilt angle of the liquid crystal molecules.

Referring again to FIG. 2, in a state where a voltage is not applied to the first electrode E11 and the second electrode E12, liquid crystal molecules LCM in the first liquid crystal layer LC1 are aligned by an alignment regulating force of the first alignment film AL11 and the second alignment film AL12, such that, in a vicinity of these alignment films, a long-axis direction of the liquid crystal molecules LCM is aligned in the alignment directions ALD1 and ALD2 of the alignment films while having the pretilt angle θp. Since the alignment direction ALD1 of the first alignment film AL11 and the alignment direction ALD2 of the second alignment film AL12 intersect (are orthogonal to) each other, the long-axis direction of the liquid crystal molecules LCM gradually changes its alignment direction from the first substrate S11 toward the second substrate S12 so as to twist by 90 degrees.

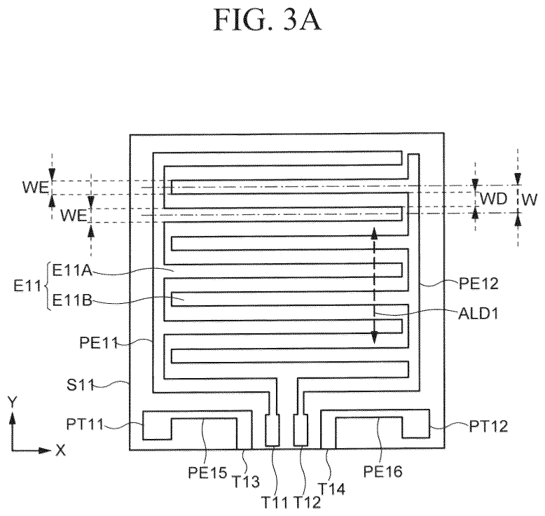

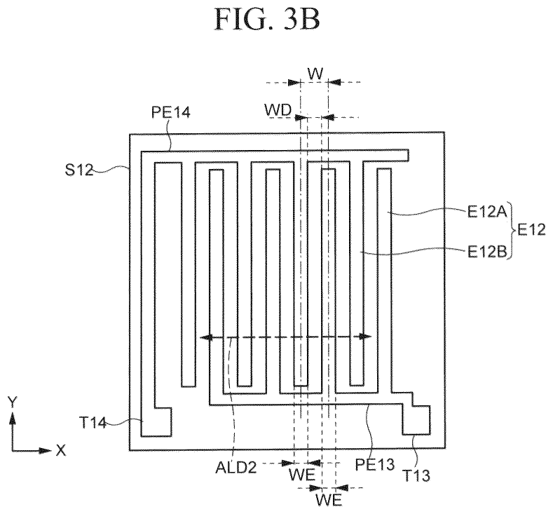

FIG. 3A is a plan view of the first substrate S11, and FIG. 3B is a plan view of the second substrate S12. As shown in FIG. 3A, the first electrode E11 has a structure in which a plurality of first strip-like electrodes E11A and a plurality of second strip-like electrodes E11B are alternately arranged. Longitudinal directions of the plurality of first strip-like electrodes E11A and the plurality of second strip-like electrodes E11B extend in the X-axis direction. In contrast, an alignment direction ALD1 of the first alignment film AL11 (not illustrated) extends in the Y-axis direction. That is, a direction of extension of the longitudinal directions of the plurality of first strip-like electrodes E11A and the plurality of second strip-like electrodes E11B and the alignment direction ALD1 intersect (are orthogonal to) each other. Similarly, as shown in FIG. 3B, the second electrode E12 has a structure in which a plurality of third strip-like electrodes E12A and a plurality of fourth strip-like electrodes E12B are alternately arranged. Longitudinal directions of the plurality of third strip-like electrodes E12A and the plurality of fourth strip-like electrodes E12B extend in the Y-axis direction. In contrast, an alignment direction ALD2 of the second alignment film AL12 (not illustrated) extends in the X-axis direction. That is, a direction of extension of the longitudinal directions of the plurality of third strip-like electrodes E12A and the plurality of fourth strip-like electrodes E12B and the alignment direction ALD2 intersect (are orthogonal to) each other.

As shown in FIG. 3A, the plurality of first strip-like electrodes E11A are each connected to a first power supply line PE11, and the plurality of second strip-like electrodes E11B are each connected to a second power supply line PE12. The first power supply line PE11 is connected to a first connection terminal T11, and the second power supply line PE12 is connected to a second connection terminal T12. The first connection terminal T11 and the second connection terminal T12 are provided at an edge portion of the first substrate S11. On the first substrate S11, a third connection terminal T13 is provided adjacent to the first connection terminal T11, and a fourth connection terminal T14 is provided adjacent to the second connection terminal T12. The third connection terminal T13 is connected to a fifth power supply line PE15. The fifth power supply line PE15 is connected to a first power supply terminal PT11 provided on the first substrate S11. The fourth connection terminal T14 is connected to a sixth power supply line PE16. The sixth power supply line PE16 is connected to a second power supply terminal PT12 provided on the first substrate S11.

The plurality of first strip-like electrodes E11A have the same voltage applied thereto via the first power supply line PE11. The plurality of second strip-like electrodes E11B have the same voltage applied thereto via the second power supply line PE12. When different voltages are applied to the first connection terminal T11 and the second connection terminal T12, a potential difference occurs between the plurality of first strip-like electrodes E11A and the plurality of second strip-like electrodes E11B, and an electric field is generated. As a result, a lateral electric field (in a Y-axis direction) is generated by the plurality of first strip-like electrodes E11A and the plurality of second strip-like electrodes E11B.

As shown in FIG. 3B, the plurality of third strip-like electrodes E12A are each connected to a third power supply line PE13, and the plurality of fourth strip-like electrodes E12B are each connected to a fourth power supply line PE14. The third power supply line PE13 is connected to the third connection terminal T13, and the fourth power supply line PE14 is connected to the fourth connection terminal T14. A third power supply terminal PT13 is provided at a position corresponding to the first power supply terminal PT11 on the first substrate S11, and a fourth power supply terminal PT14 is provided at a position corresponding to the second power supply terminal PT12 on the first substrate S11. The third power supply terminal PT13 and the first power supply terminal PT11, and the fourth power supply terminal PT14 and the second power supply terminal PT12 are electrically connected to each other. Conductive paste is used for electrical connection between these power supply terminals. For example, silver paste is used as the conductive paste.

When different voltages are applied to the third connection terminal T13 and the fourth connection terminal T14, a potential difference occurs between the plurality of third strip-like electrodes E12A and the plurality of fourth strip-like electrodes E12B, and an electric field is generated. As a result, a lateral electric field (in an X-axis direction) is generated by the plurality of third strip-like electrodes E12A and the plurality of fourth strip-like electrodes E12B.

The first substrate S11 and the second substrate S12 are light-transmitting substrates, for example glass substrates or resin substrates. The first electrode E11 and the second electrode E12 are transparent electrodes formed of indium tin oxide (ITO), indium zinc oxide (IZO), or the like. Power supply lines (the first power supply line PE11, the second power supply line PE12, the third power supply line PE13, and the fourth power supply line PE14) and connection terminals (the first connection terminal T11, the second connection terminal T12, the third connection terminal T13, and the fourth connection terminal T14) are formed of metal materials such as aluminum, titanium, molybdenum, or tungsten. The power supply lines (the first power supply line PE11, the second power supply line PE12, the third power supply line PE13, and the fourth power supply line PE14) may alternatively be formed of the same transparent conductive film as the first electrode E11 and the second electrode E12. Naturally, a configuration may also be adopted in which either one or both of the first electrode E11 and the second electrode E12 are formed of a metal material, or of a stacked structure in which a metal material is laminated on a transparent conductive film.

As shown in FIG. 3A, the first strip-like electrode E11A and the second strip-like electrode E11B are arranged at a center-to-center distance W. The center-to-center distance W has a relationship of W=WE+WD with respect to a width WE of the first strip-like electrode E11A and the second strip-like electrode E11B shown in FIG. 3A and a spacing WD between an end of the first strip-like electrode E11A and an end of the second strip-like electrode E11B. The same applies to the center-to-center distance W, the width WE, and the spacing WD of the third strip-like electrode E12A and the fourth strip-like electrode E12B shown in FIG. 3B. A width WE of the strip-like electrodes can be, for example, 4 μm or greater, and an electrode spacing WD may be made equal to the width WE or may be set to a different value. In the liquid crystal panel constituting the liquid crystal light control element 102, the center-to-center distance W of the strip-like electrodes and a thickness D of the first liquid crystal layer LC1 (that is, a spacing D between the first substrate S11 and the second substrate S12) have a close relationship, and by setting a value of D/W to be 1 or greater, light of a predetermined deflection component can be sufficiently diffused (spread in a predetermined direction). For example, when the width WE of the strip-like electrodes is 4 μm and the electrode spacing WD is 4 μm, it is preferable that the thickness D of the first liquid crystal layer LC1 be 12 μm or greater.

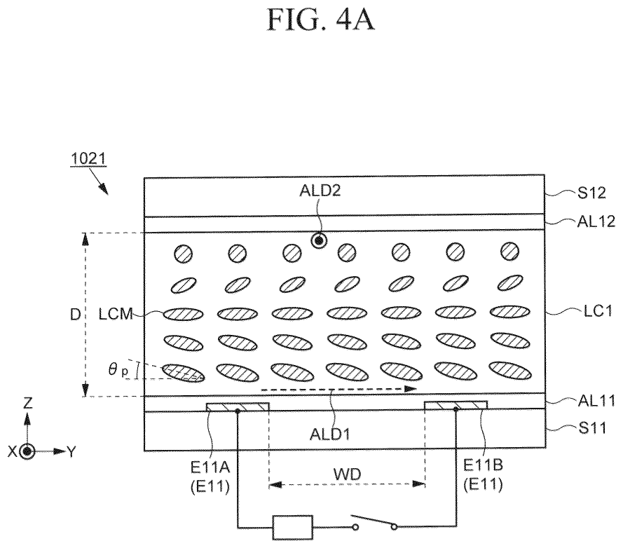

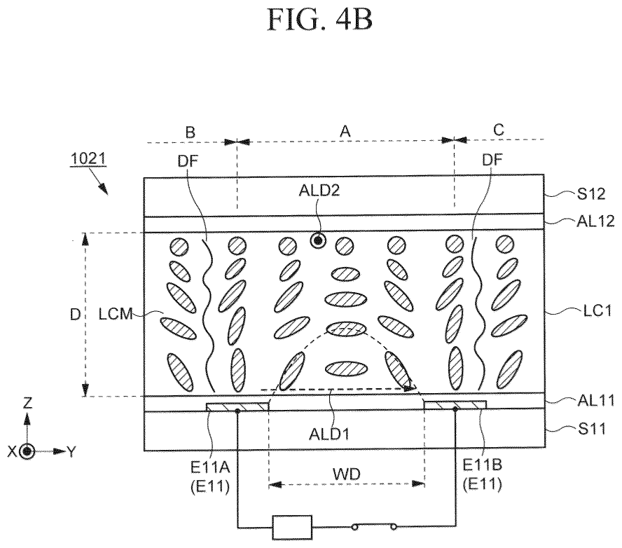

FIG. 4A and FIG. 4B are diagrams for explaining an operation of the first liquid crystal panel 1021, and show a structure obtained when the first liquid crystal panel 1021 shown in FIG. 2 is viewed from an XA side. FIG. 4A illustrates a state in which no voltage is applied to the first electrode E11 (the first strip-like electrodes E11A and the second strip-like electrodes E11B), and FIG. 4B illustrates a state in which a voltage is applied to the first electrode E11 and a lateral electric field is generated between the first strip-like electrodes E11A and the second strip-like electrodes E11B.

The first strip-like electrode E11A and the second strip-like electrode E11B have longitudinal directions of strip-like patterns extending in the X-axis direction and are arranged with a spacing WD. Here, when a thickness D of the first liquid crystal layer LC1 is compared with an electrode spacing WD of the first electrode E11, the thickness D of the first liquid crystal layer LC1 is equal to or greater than the electrode spacing WD (D≥WD). For example, the thickness D of the first liquid crystal layer LC1 is at least twice as large as the electrode spacing WD of the first electrode E11. For example, when the thickness D of the first liquid crystal layer LC1 is 10 μm, the electrode spacing WD can be 5 μm, and when the thickness D of the first liquid crystal layer LC1 is 50 μm, the electrode spacing WD can be 10 μm.

An alignment direction of the first alignment film AL11 extends in the Y-axis direction, and an alignment direction of the second alignment film AL12 extends in the X-axis direction. In a state where no electric field acts on the first liquid crystal layer LC1 (FIG. 4A), a long-axis direction of liquid crystal molecules LCM has a pretilt angle θp and is aligned in a state twisted by 90 degrees from the first substrate side toward the second substrate side. In this case, the first liquid crystal layer LC1 has a uniform refractive index distribution. When light is incident on the first liquid crystal panel 1021, a polarization component of the incident light undergoes optical rotation due to twisting of the liquid crystal molecules LCM. At this time, the incident light is transmitted through the first liquid crystal layer LC1 while undergoing optical rotation, without being refracted (or scattered).

On the other hand, when a voltage is applied to the first electrode E11 and a lateral electric field is generated between the first strip-like electrode E11A and the second strip-like electrode E11B, a long axis of the liquid crystal molecules LCM is oriented along the electric field (in a case where the liquid crystal has positive dielectric anisotropy). As a result, as shown in FIG. 4B, a region in which the liquid crystal molecules LCM rise above the first strip-like electrode E11A and the second strip-like electrode E11B, and a region in which the liquid crystal molecules LCM are obliquely oriented between the first strip-like electrode E11A and the second strip-like electrode E11B along a distribution of the electric field are formed. At this time, when a thickness D of the first liquid crystal layer LC1 is sufficiently large (10 μm or greater), that is, when the thickness D of the first liquid crystal layer LC1 is sufficiently large, an influence of the electric field formed by the first electrode E11 does not reach a second substrate side of the second substrate S12, and an alignment state of the liquid crystal molecules LCM changes only on a first substrate side. That is, on the second substrate side, the liquid crystal molecules LCM remain in a state in which they are not affected by the electric field and their alignment does not change.

As shown in FIG. 4B, when a lateral electric field is generated between the first strip-like electrode E11A and the second strip-like electrode E11B, the liquid crystal molecules LCM are oriented in a convex arcuate manner such that a long axis of the liquid crystal molecules is along a direction in which the electric field is generated. A liquid crystal having dielectric anisotropy also undergoes a change in a distribution of a dielectric constant into an arcuate shape due to a change in this alignment state of the liquid crystal molecules LCM. In this state, when light is incident from the first substrate side of the first substrate S11, a polarization component parallel to the Y-axis direction is radially diffused by the dielectric constant distribution. On the other hand, a polarization component parallel to the X-axis direction is not affected by the dielectric constant distribution and enters the first liquid crystal layer LC1 without being diffused. In this way, by aligning the liquid crystal molecules LCM in a predetermined direction and changing their alignment state by the lateral electric field, a specific polarization component among incident light can be diffused (a light distribution of the specific polarization component can be broadened).

Although FIG. 4A and FIG. 4B describe an effect of the first electrode E11 on the liquid crystal molecules LCM and incident light, the same applies to an effect of the second electrode E12 of the second substrate S12 on the first liquid crystal layer LC1. That is, on the second substrate side, by generating a lateral electric field by the second electrode E12, a polarization component parallel to the X-axis direction can be diffused (a light distribution of the polarization component can be broadened).

As described with reference to FIG. 4A and FIG. 4B, the first liquid crystal panel 1021 can diffuse incident light in a predetermined direction. Accordingly, by using the first liquid crystal panel 1021, it is possible to control a light distribution state of light emitted from a light source. However, when strong light is irradiated onto alignment films (the first alignment film AL11 and the second alignment film AL12), the alignment films may deteriorate due to an influence of the light. This influence may be non-negligible particularly in alignment films formed of an organic material such as a polyimide-based material. In a liquid crystal display, the alignment films are also exposed to light from a backlight, but deterioration of the alignment films does not become a problem because the luminous intensity is lower than that of a light source for illumination and the light is polarized by a polarizer. In contrast, in a case where the liquid crystal light control element 102 of the present embodiment is used for lighting purposes and strong light from the light source is incident, the alignment films are in a situation where they are likely to deteriorate.

When an alignment film deteriorates, it becomes problematic that an alignment regulating force on the liquid crystal molecules LCM is reduced. When the alignment regulating force is reduced, a direction in which the liquid crystal molecules LCM twist is no longer fixed, and, when application of a voltage is turned off and the electric field is removed, a phenomenon appears in which a direction of twist is reversed (hereinafter also referred to as “reverse twist”), so that alignment of the liquid crystal molecules LCM becomes unstable.

In view of such a phenomenon, in the present embodiment, since the liquid crystal molecules LCM have a pretilt angle θp, it is possible to suppress the occurrence of reverse twist. When the pretilt angle θp is 2 degrees or more, the occurrence of reverse twist can be reduced, and when the pretilt angle θp is 3 degrees or more, the occurrence of reverse twist can be substantially eliminated.

FIG. 4B illustrates a region A in which liquid crystal molecules LCM are aligned by a lateral electric field formed between the first strip-like electrode E11A and the second strip-like electrode E11B, and illustrates regions B and C as regions adjacent thereto. As described with reference to FIG. 3A, since a plurality of first strip-like electrodes E11A and a plurality of second strip-like electrodes E11B are alternately arranged on the first substrate S11, a lateral electric field is also generated in the regions B and C adjacent to the region A. However, directions of the lateral electric field (directions of electric field lines) in the regions B and C are opposite to that in the region A. Therefore, as shown in FIG. 4B, an alignment defect DF occurs on the first strip-like electrode E11A and the second strip-like electrode E11B.

This alignment defect DF occurs at a central portion of the electrodes when the alignment of the liquid crystal molecules LCM has no pretilt angle. However, when the liquid crystal molecules LCM are aligned with a pretilt, it becomes problematic that stability depends on a direction and a magnitude of the pretilt. Specifically, it has been found that when the pretilt angle of the liquid crystal molecules LCM is 8 degrees or greater, instability increases, whereas when the pretilt angle is 6 degrees or less, no problem arises in terms of instability.

According to the above, to improve the reliability of the first liquid crystal panel 1021, it can be said that a pretilt angle θp of the liquid crystal molecules LCM is preferably 2 degrees or more and less than 8 degrees, and more preferably 3 degrees or more and 6 degrees or less. It is to be noted that, in FIG. 2, FIG. 4A, and FIG. 4B, alignment directions of the alignment films are illustrated for a parallel rubbing configuration, but an anti-parallel rubbing configuration may also be employed.

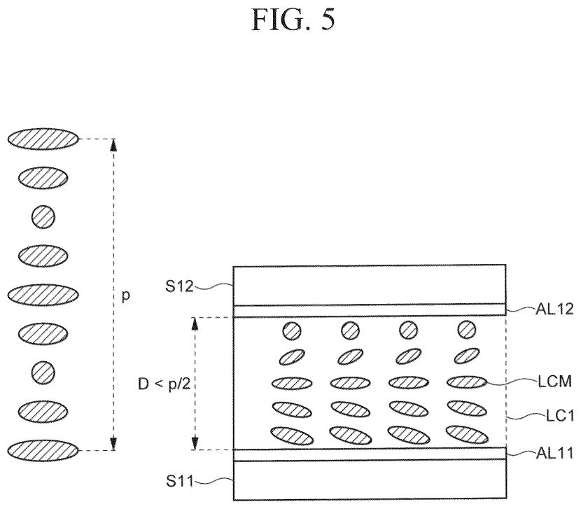

The first liquid crystal layer LC1 in the present embodiment is a twisted nematic liquid crystal, as described in FIG. 2, and is oriented with a 90 degrees twist from the first substrate S11 side to the second substrate S12 side. In order to suppress reverse twist that occurs when an electric field is removed, the first liquid crystal layer LC1 may include a chiral material. As shown in FIG. 5, with respect to a pitch p of the chiral material (a distance over which the liquid crystal is twisted by 360 degrees by the chiral material), it is preferable that a thickness D of the first liquid crystal layer LC1 be less than one half (½) of the pitch p (D<p/2). More preferably, the thickness D of the first liquid crystal layer LC1 is greater than one eighth (⅛) of the pitch p and less than one half (½) of the pitch p (p/8<D<p/2). When the thickness D of the first liquid crystal layer LC1 becomes greater than one half of the pitch p of the chiral material, there is a possibility that a twist of the liquid crystal becomes 270 degrees instead of 90 degrees. In addition, in order to obtain an effect of adding the chiral material, it is preferable that the thickness D of the first liquid crystal layer LC1 be greater than one eighth of the pitch p.

### 3. Operation of Liquid Crystal Panel

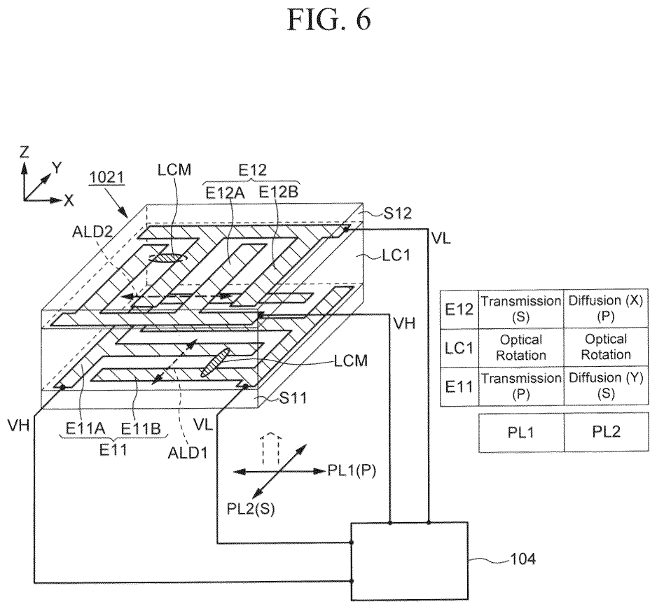

FIG. 6 shows the first liquid crystal panel 1021, and illustrates a state in which the first strip-like electrode E11A and the second strip-like electrode E11B of the first electrode E11 extend in the X-axis direction, and the third strip-like electrode E12A and the fourth strip-like electrode E12B of the second electrode E12 extend in the Y-axis direction. An alignment direction ALD1 of a first alignment film AL11 (not shown in the figure) is parallel to the Y-axis direction, and an alignment direction ALD2 of a second alignment film AL12 (not shown in the figure) is parallel to the X-axis direction. Accordingly, a long axis of the liquid crystal molecules LCM on a first substrate side is directed in the Y-axis direction, and a long-axis direction of the liquid crystal molecules LCM on a second substrate side is directed in the X-axis direction.

FIG. 6 also illustrates a state in which, from the control circuit 104, a high-level voltage VH is applied to the first strip-like electrode E11A and a low-level voltage VL (VH>VL) is applied to the second strip-like electrode E11B, and a high-level voltage VH is applied to the third strip-like electrode E12A and a low-level voltage VL (VH>VL) is applied to the fourth strip-like electrode E12B.

Light emitted from the light source has a first polarized component PL1 and a second polarized component PL2, and is incident on the first liquid crystal panel 1021 from the first substrate side. Here, the first polarized component PL1 corresponds to a P wave having an amplitude in the X-axis direction, and the second polarized component PL2 corresponds to an S wave having an amplitude in the Y-axis direction. As shown in a table inserted in FIG. 6, light incident on the first liquid crystal panel 1021 undergoes optical actions such as transmission, optical rotation, and diffusion by the first liquid crystal layer LC1.

Here, “transmission” in the table indicates that a polarization axis of a predetermined polarized component does not change and a light distribution state does not change, and the light is transmitted as it is. “Diffusion (Y)” indicates that the polarized component is diffused in a direction parallel to the Y-axis direction. Although not shown in FIG. 6, when “Diffusion (X)” is indicated, it means that the polarized component is diffused in a direction parallel to the X-axis direction.

Since the first polarized component PL1 is a P wave, it's the polarization direction on the first electrode E11 side intersects a long-axis direction of the liquid crystal molecules LCM and is transmitted as it is without being affected by an arcuate refractive index distribution formed by the alignment of the liquid crystal molecules LCM. As the first polarized component PL1 travels through the first liquid crystal layer LC1 from the first substrate side toward the second substrate side, it undergoes optical rotation of 90 degrees and transitions to a state as an S wave. The first polarized component PL1 having transitioned to the S-wave state has its polarization direction intersecting the long-axis direction of the liquid crystal molecules LCM on the second electrode E12 side, and is transmitted as it is without being affected by the arcuate refractive index distribution formed by the alignment of the liquid crystal molecules LCM.

On the other hand, the second polarized component PL2 is an S wave, and the polarization direction on the first electrode E11 side is parallel to the long-axis direction of the liquid crystal molecules LCM, so that it is affected by an arcuate refractive index distribution formed by the alignment of the liquid crystal molecules LCM and is diffused in the Y-axis direction. As the second polarized component PL2 travels through the first liquid crystal layer LC1 from the first substrate side toward the second substrate side, it undergoes optical rotation of 90 degrees and transitions to a state as a P wave. The second polarized component PL2 having transitioned to the P-wave state has its polarization direction parallel to the long-axis direction of the liquid crystal molecules LCM on the second electrode E12 side, and is diffused in the X-axis direction under the influence of the arcuate refractive index distribution formed by the alignment of the liquid crystal molecules LCM.

Thus, when light is incident on the first liquid crystal panel 1021 from the first substrate side of the first substrate S11, the first polarized component PL1 (P wave) is not diffused, undergoes optical rotation in the first liquid crystal layer LC1, and is emitted in a state as an S wave, and the second polarized component PL2 (S wave) is diffused once in the Y-axis direction and once in the X-axis direction, undergoes optical rotation in the first liquid crystal layer LC1, and is emitted in a state as a P wave.

FIG. 6 illustrates an example in which the second polarized component PL2 (S wave) is diffused in the Y-axis direction and the X-axis direction by the first liquid crystal panel 1021, but by combining a plurality of liquid crystal panels, it is also possible to diffuse the first polarized component PL1 (P wave).

### 4. Operation of Liquid Crystal Light Control Element

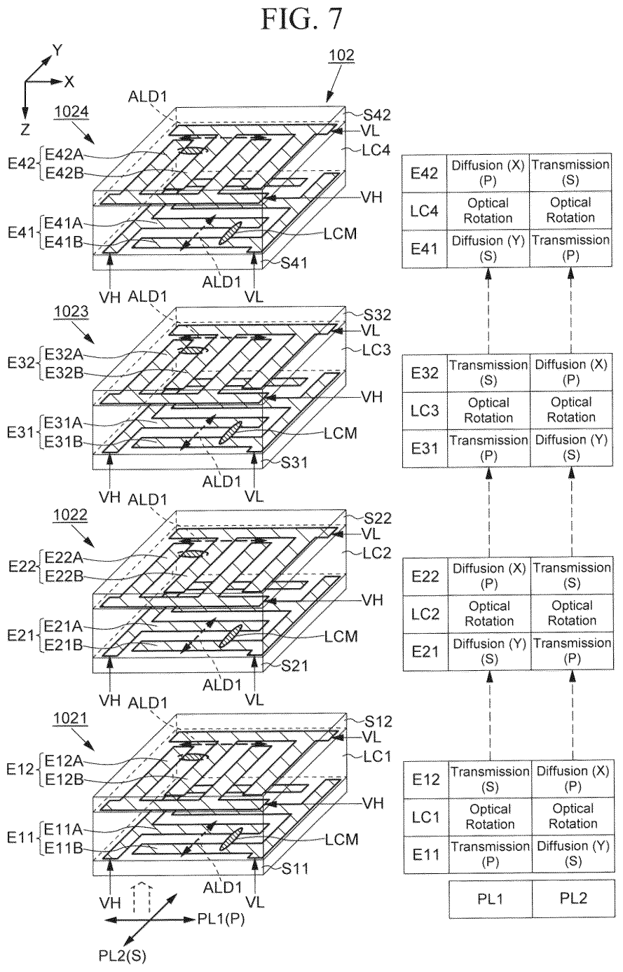

FIG. 7 illustrates an example of an operation of the liquid crystal light control element 102. As described with reference to FIG. 1, the liquid crystal light control element 102 is formed of four liquid crystal panels (a first liquid crystal panel 1021, a second liquid crystal panel 1022, a third liquid crystal panel 1023, and a fourth liquid crystal panel 1024) each having the same configuration as the first liquid crystal panel 1021. FIG. 7 schematically shows, for purposes of explanation, a state in which the respective liquid crystal panels are arranged spaced apart from one another, whereas, in an actual liquid crystal light control element 102, the liquid crystal panels have a structure in which they are bonded together by a transparent adhesive.

The second liquid crystal panel 1022, the third liquid crystal panel 1023, and the fourth liquid crystal panel 1024 have configurations similar to that of the first liquid crystal panel 1021 shown in FIG. 6. That is, the second liquid crystal panel 1022 has a first substrate S21, a second substrate S22, a first electrode E21, a second electrode E22, and a second liquid crystal layer LC2; the third liquid crystal panel 1023 has a first substrate S31, a second substrate S32, a first electrode E31, a second electrode E32, and a third liquid crystal layer LC3; and the fourth liquid crystal panel 1024 has a first substrate S41, a second substrate S42, a first electrode E41, a second electrode E42, and a fourth liquid crystal layer LC4. It is to be noted that, in FIG. 7, alignment films provided in the respective liquid crystal panels are omitted from illustration for the sake of simplicity.

The first electrodes E11, E21, E31, and E41 are formed of first strip-like electrodes E11A, E21A, E31A, and E41A, and second strip-like electrodes E11B, E21B, E31B, and E41B, and these strip-like electrodes extend in the X-axis direction. The second electrodes E12, E22, E32, and E42 are formed of third strip-like electrodes E12A, E22A, E32A, and E42A, and fourth strip-like electrodes E12B, E22B, E32B, and E42B, and these strip-like electrodes extend in the Y-axis direction.

A low-level voltage VL, high-level voltage VH, and constant voltage CV are applied to each liquid crystal panel as control signals. The low-level voltage VL is, for example, a voltage of 0 V or −15 V, and the high-level voltage VH is, for example, 30 V (when VL=0 V) or 15 V (when VL=−15 V). The constant voltage CV is, for example, a voltage signal that is an intermediate voltage between VL and VH, or 0 V (ground potential).

FIG. 7 illustrates a state in which a high-level voltage VH and a low-level voltage VL are applied, as control signals, to the first electrode E11 and the second electrode E12 of the first liquid crystal panel 1021, the first electrode E21 and the second electrode E22 of the second liquid crystal panel 1022, the first electrode E31 and the second electrode E32 of the third liquid crystal panel 1023, and the first electrode E41 and the second electrode E42 of the fourth liquid crystal panel 1024. That is, liquid crystal molecules are in a state of being aligned by lateral electric fields on sides of the first substrates S11, S21, S31, and S41 and the second substrates S12, S22, S32, and S42 of the respective liquid crystal panels.

FIG. 7 illustrates that light emitted from the light source is incident from the first liquid crystal panel 1021 side and is emitted from the fourth liquid crystal panel 1024 side. The light emitted from the light source includes the first polarized component PL1 (P wave) and the second polarized component PL2 (S wave), and a table inserted in FIG. 6 shows how diffusion, optical rotation, and transmission change in the respective liquid crystal panels.

In the light incident on the first liquid crystal panel 1021, the first polarized component PL1 (P wave) is transmitted on the first electrode E11 side, undergoes optical rotation in the first liquid crystal layer LC1 and transitions to an S-wave state, and is then transmitted on the second electrode E12 side and emitted. The second polarized component PL2 (S wave) is diffused in the Y-axis direction on the first electrode E11 side, undergoes optical rotation in the first liquid crystal layer LC1 and transitions to a P-wave state, and is then diffused in the X-axis direction on the second electrode E12 side and emitted. In this way, by passing through the first liquid crystal panel 1021, the polarization states of the first polarized component PL1 and the second polarized component PL2 change, and the second polarized component PL2 is diffused in the Y-axis direction and the X-axis direction and emitted.

A similar phenomenon also occurs in the second liquid crystal panel 1022, the third liquid crystal panel 1023, and the fourth liquid crystal panel 1024. That is, the first polarized component PL1 and the second polarized component PL2 incident on the second liquid crystal panel 1022 undergo a change in polarization state by passing through the second liquid crystal panel 1022, and the first polarized component PL1 is diffused in the Y-axis direction and the X-axis direction and emitted. The first polarized component PL1 and the second polarized component PL2 incident on the third liquid crystal panel 1023 undergo a change in polarization state by passing through the third liquid crystal panel 1023, and the second polarized component PL2 is diffused in the Y-axis direction and the X-axis direction and emitted. Then, the first polarized component PL1 and the second polarized component PL2 incident on the fourth liquid crystal panel 1024 undergo a change in polarization state by passing through the fourth liquid crystal panel 1024, and the first polarized component PL1 is diffused in the Y-axis direction and the X-axis direction and emitted.

Thus, the first polarized component (P wave) of light emitted from the light source is diffused twice in the Y-axis direction and twice in the X-axis direction by passing from the first liquid crystal panel 1021 through the fourth liquid crystal panel 1024, and the second polarized component (S wave) is also diffused twice in the Y-axis direction and twice in the X-axis direction by passing from the first liquid crystal panel 1021 through the fourth liquid crystal panel 1024. Accordingly, since the first polarized component PL1 and the second polarized component PL2 are uniformly diffused in the X-axis direction and the Y-axis direction, a rectangular light distribution pattern can be formed.

It is to be noted that the voltage application conditions shown in FIG. 7 are merely an example, and various alignment patterns can be formed by combinations of voltage application conditions. For example, by applying a voltage application pattern that causes diffusion only in the X-axis direction or only in the Y-axis direction to the first polarized component PL1 (P wave) and the second polarized component PL2 (S wave), it is possible to form a line-shaped light distribution pattern. Further, by adopting a voltage application pattern in which a polarized component in a P-wave state is diffused in the X-axis direction and a polarized component in an S-wave state is diffused in the Y-axis direction for the first polarized component PL1 (P wave) and the second polarized component PL2 (S wave), it is possible to form a cross-shaped light distribution pattern. The number of liquid crystal panels constituting the liquid crystal light control element 102 is not limited to four and can be further increased. In addition, the manner in which the respective liquid crystal panels are stacked can be varied. For example, an upper liquid crystal panel may be rotated by a predetermined angle with respect to a lower liquid crystal panel and then stacked.

In the liquid crystal light control element 102 capable of having such a configuration and operation, since the liquid crystal molecules are controlled to have a pretilt angle θp, even when strong light from the light source is incident and the alignment films deteriorate, it is possible to suppress disorder in alignment of the liquid crystal layer. Accordingly, reliability of the liquid crystal light control device 100 can be improved.

Various configurations of the liquid crystal light control device illustrated as one embodiment of the present invention can be combined with one another as appropriate, as long as they do not conflict with each other. In addition, based on the liquid crystal light control device disclosed in the present specification and the drawings, modifications in which a person skilled in the art appropriately adds, deletes, or redesigns constituent elements, or adds, omits, or changes processing steps or conditions, are also included within the scope of the present invention as long as they embody the gist of the present invention.

Even other effects that are different from the effects brought about by the embodiments disclosed in the present specification are naturally understood to be achieved by the present invention, as long as such effects are apparent from the description in the present specification or can be readily predicted by a person skilled in the art.

What is claimed is:

1. A liquid crystal light control device, comprising:
at least one liquid crystal panel including:
a first substrate provided with a first electrode including a strip-like pattern, and a first alignment film covering the first electrode;
a second substrate provided with a second electrode including a strip-like pattern, and a second alignment film covering the second electrode; and
a liquid crystal layer disposed between the first substrate and the second substrate,
wherein the liquid crystal layer has a thickness of 10 μm or more and liquid crystal molecules are aligned in a twisted manner from a first substrate side toward a second substrate side, and
wherein a pretilt angle of the liquid crystal molecules controlled by the first alignment film and the second alignment film is 2 degrees or more and less than 8 degrees.

2. The liquid crystal light control device according to claim 1, wherein the pretilt angle of the liquid crystal molecules controlled by the first alignment film and the second alignment film is 3 degrees or more and 6 degrees or less.

3. The liquid crystal light control device according to claim 2, wherein the liquid crystal layer comprises twisted nematic liquid crystal.

4. The liquid crystal light control device according to claim 3, wherein a longitudinal direction of the strip-like pattern of the first electrode intersects a longitudinal direction of the strip-like pattern of the second electrode, and
wherein a long-axis direction of the liquid crystal molecules is aligned:
on the first substrate side to intersect the longitudinal direction of the strip-like pattern of the first electrode; and
on the second substrate side to intersect the longitudinal direction of the strip-like pattern of the second electrode.

5. The liquid crystal light control device according to claim 4, wherein the first electrode includes a plurality of first strip-like electrodes and a plurality of second strip-like electrodes extending in a first direction; and
the second electrode includes a plurality of third strip-like electrodes and a plurality of fourth strip-like electrodes extending in a second direction intersecting the first direction.

6. The liquid crystal light control device according to claim 5, wherein the first strip-like electrodes and the second strip-like electrodes are arranged in the second direction at a center-to-center distance W, and when a thickness of the liquid crystal layer is D, D/W is greater than or equal to 1.

7. The liquid crystal light control device according to claim 1, wherein the liquid crystal layer contains a chiral material.

8. The liquid crystal light control device according to claim 7, wherein a relationship between a thickness d of the liquid crystal layer and a pitch p of the chiral material satisfies D<p/2.

9. The liquid crystal light control device according to claim 7, wherein a relationship between the thickness d of the liquid crystal layer and the pitch p of the chiral material satisfies p/8<D<p/2.

10. The liquid crystal light control device according to claim 1, wherein the at least one liquid crystal panel comprises a plurality of liquid crystal panels, and the plurality of liquid crystal panels are stacked.
